(19) United States
(12) Patent Application Publication
(10) Pub. No.: US 2014/0334338 A1
(43) Pub. Date: Nov. 13, 2014

(54) METHOD OF GENERATING PEER SERVICE GROUP AND ACCESSING LINK RESOURCES IN PEER SERVICE GROUP

(71) Applicant: ELECTRONICS AND TELECOMMUNICATIONS RESEARCH INSTITUTE, Daejeon (KR)

(72) Inventor: Seong-Soon JOO, Daejeon (KR)

(73) Assignee: ELECTRONICS AND TELECOMMUNICATIONS RESEARCH INSTITUTE, Daejeon (KR)

(21) Appl. No.: 14/276,637

(22) Filed: May 13, 2014

(30) Foreign Application Priority Data
May 13, 2013 (KR) 10-2013-0053893
Jul. 17, 2013 (KR) 10-2013-0083896
May 13, 2014 (KR) 10-2014-0057465

(51) Int. Cl. H04W 4/08; H04W 56/00; H04W 8/00

(52) U.S. Cl. CPC H04W 4/08; H04W 8/005; H04W 56/001; H04W 8/22
USPC 370/254

(57) ABSTRACT

A method in which a peer generates a peer service group includes: determining whether a first peer service group that provides a peer service requested from user exists in the vicinity; participating, if the first peer service group exists, in the first peer service group; and generating, if the first peer service group does not exist, a second peer service group that provides the peer service, and a method of accessing a link resource that accesses a group link, a guest link, a relay link, a group link, and a idle link of a peer service group are provided.

### CROSS-REFERENCE TO RELATED APPLICATION

This application claims priority to and the benefit of Korean Patent Application Nos. 10-2013-0053893, 10-2013-0083896 and 10-2014-0057465 filed in the Korean Intellectual Property Office on May 13, 2013, Jul. 17, 2013 and May 13, 2014, the entire contents of which are incorporated herein by reference.

### BACKGROUND OF THE INVENTION

(a) Field of the Invention

The present invention relates to a method of generating a peer service group and a method of accessing a link resource of a peer service group.

(b) Description of the Related Art

In the Internet of things (IoT), in order for things that are located at the same space to recognize a situation change of space and to adaptively correspond to an event, grouping between things and cooperation between grouped things is requested.

A plurality of things that are located at the same space may belong to at least one group, operate as a client or a server with a peer to peer (P2P), and transmit/receive control information, sensing information, location information, advertisements, or multimedia contents. For this purpose, in order to access to various resources, the plurality of things should form a peer service group.

In the conventional art on a network configuration based on a low power wireless link, there is an IEEE 802.15.4-based standard. Conventionally, wireless personal area network (WPAN) technology controls a network and a master coordinator for a network configuration to form a link between full function devices.

However, it is difficult for a device to simultaneously participate in a plurality of networks, so it provides a plurality of links without overall control in the plurality of networks.

The above information disclosed in this Background section is only for enhancement of understanding of the background of the invention and therefore it may contain information that does not form the prior art that is already known in this country to a person of ordinary skill in the art.

### SUMMARY OF THE INVENTION

The present invention has been made in an effort to provide a method in which a peer generates a peer service group

An exemplary embodiment of the present invention provides a method in which a peer generates a peer service group. The method includes: determining whether a first peer service group that provides a peer service requested from user exists in the vicinity; participating, if the first peer service group exists, in the first peer service group; and generating, if the first peer service group does not exist, a second peer service group that provides the peer service.

The method may further include before the determining: searching frames transmitted from neighbor peer service group that exists in the vicinity; and synchronizing clock using synchronization frame of the frames.

The method may further include, if the frames have not been received, resetting reception period of the frames and searching the frames again.

The method may further include, if the frames have not been received, determining whether the peer can broadcast synchronization frame through device capability information stored in the peer.

The determining whether the peer can broadcast the synchronization frame may include: determining whether the peer has information of master clock capable and main powered through the device capability information.

The method may further include: broadcasting, if the peer can broadcast the synchronization frame, the synchronization frame; determining whether the peer can discover another peer through network service capability information stored in the peer; discovering, if the peer can discover the another peer, the another peer; and setting wake-up time and converting a mode thereof to a sleep mode if the peer cannot discover the another peer.

The generating may include: determining whether the peer can discover another peer through network service capability information stored in the peer; discovering, if the peer can discover the another peer, the another peer; and setting wake-up time and converting a mode thereof to a sleep mode if the peer cannot discover the another peer.

The discovering the another peer may include: transmitting, if the second peer service group is a handshaking phase, a peer discovery request and data; retransmitting the peer discovery request and data when a peer discovery response or peer data acknowledgement (ACK) is not received within a predetermined first time; and completing generation of the second peer service group when the peer discovery response or the ACK is received within the first time.

The discovering the another peer further may include: completing generation of the second peer service group when the peer discovery response or the ACK is received within a predetermined second time after the retransmission; and determining a generation failure of the second peer service group when the peer discovery response or the ACK is not received within the second time.

The discover the another peer may include: determining, if the start phase is not a handshaking phase, whether peering is necessary; transmitting, if peering is unnecessary, a peer discovery request; retransmitting the peer discovery request when the peer discovery response is not received within a predetermined first time; and completing generation of the second peer service group when the peer discovery response is received within the first time.

The discover the another peer further may include: completing generation of the second peer service group when the peer discovery response is received within a predetermined second time after the retransmission; and determining a generation failure of the second peer service group when the peer discovery response is not received within the second time.

The discover the another peer further may include: transmitting, if peering is necessary, a peer discovery request; retransmitting the peer discovery request when the peer discovery response is not received within a predetermined first time; determining whether a peering request information is received when the peer discovery response is received within the first time; transmitting, if the peering request information is received, a first peering response; and completing generation of the second peer service group. The method may further include: transmitting, if the peering request information is not received, a peering request; transmitting a third peering response when a second peering response to the peering request is received; and completing generation of the second peer service group.

The method may further include: retransmitting, it the second peering response is not received, the peering request; transmitting a fifth peering response when a fourth peering response to the retransmitted peering request is received; and completing generation of the second peer service group.

The discover the another peer may further include: transmitting a peering response and completing generation of the second peer service group when the peer discovery response is received within a predetermined second time after the retransmission; and determining a generation failure of the second peer service group when the peer discovery response is not received within the second time.

The peer may performs a server function, defines a mission of a peer service group and a peer group, and is a host peer that authenticates the another peer.

The other peer may be a guest peer that requests generation of a peer service group to the host peer.

Another embodiment of the present invention provides a method in which a peer accesses to a link resource of a peer service group. The method includes: receiving service phase descriptor; and accessing the link resource according to the service phase descriptor, wherein the service phase descriptor includes information about service phase determined according to peer service requested by user.

The information about the service phase may include discovery phase, peering phase, P2P data phase and handshaking phase, and each phase can be represented superframe including at least one of group link, idle link, contention link, contention free link and relay link.

The method may further include: determining, when the service phase is the discovery phase, a start time of the superframe; and transmitting, by a first group link, a discovery message to another peer, wherein the peer accesses the first host link with a prioritized slotted Carrier Sense Multiple Access/Collision Avoidance (CSMA/CA) method.

The method may further include receiving a first message from a first peer different from the peer in a first guest link after the first group link, wherein the peer accesses the first guest link with a slotted CSMA/CA method.

The method may further include receiving a second message of a second peer different from the first peer from the first peer in a first relay link after the first guest link, wherein the peer accesses the first relay link with a slotted CSMA/CA method.

The first group link, the first guest link, and the first relay link may be a link resource of a unit of a first time slot that is determined based on a target time that is consumed for generating the peer service group, the number of peers that are included in the peer service group, and a distance between the peer and the first peer.

The method may further include accessing a first idle link before the determining of the superframe start time.

The method may further include sequentially accessing a second group link, a second guest link, a second idle link, and a second relay link after the first relay link.

The second group link, the second guest link, the second relay link, and the second idle link may be a link resource of a unit of a second time slot that is determined based on a magnitude of a message of the second group link, the second guest link, the second relay link, and the second idle link, a mission of the peer service group, the number of peers that are included in the peer service group, and a distance between the peer and the first peer, between the peer and the second peer, or between the first peer and the second peer.

The discovery message may include a peer service group ID, the service phase descriptor, and a frame transmission time.

The method may further include: determining, when the service phase is the handshaking phase, a start time of the superframe; transmitting, by a first group link, a discovery message to another peer; accessing a first idle link; receiving, by a first guest link, a first message from a first peer different from the peer; and accessing a second idle link.

The method may further include repeating the transmitting of a discovery message, the accessing of a first idle link, the receiving of a first message by the first guest link, and the accessing of a second idle link.

The group link, the first idle link, the first guest link, and the second idle link may be a link resource of a unit of a time slot that is determined based on a magnitude of a message of the group link, the first idle link, the first guest link, and the second idle link, a target time that is consumed for collecting information of the peer service group, a mission of the peer service group, and the number of peers that are included in the peer service group.

### BRIEF DESCRIPTION OF THE DRAWINGS

FIG. 1 is a diagram illustrating a network in which each terminal is included in at least one group of a plurality of groups that are included in a space.

FIG. 2 is a diagram illustrating an example in which each thing of FIG. 1 generates a peer service group.

FIG. 3 is a diagram illustrating an example in which a new thing participates in the peer service group of FIG. 2 and generates a new peer service group.

FIG. 4 is a diagram illustrating a peer service group using a low power wireless link according to an exemplary embodiment of the present invention.

FIG. 5 is a flowchart illustrating an initialization process of a peer that is included in a peer service group according to an exemplary embodiment of the present invention.

FIG. 6A, FIG. 6B and FIG. 6C are flowcharts illustrating a method of generating a single peer network according to an exemplary embodiment of the present invention.

FIG. 7 is a diagram illustrating a header of a media access control (MAC) frame of a peer service group according to an exemplary embodiment of the present invention.

FIG. 8 is a diagram illustrating a link represented by superframe according to an exemplary embodiment of the present invention.

FIG. 9 is a diagram illustrating a phase configuration method of a peer service according to an exemplary embodiment of the present invention.

FIG. 10 is a diagram illustrating each phase of a peer service group according to an exemplary embodiment of the present invention.

FIG. 11 is a diagram illustrating a time synchronization correction method between peer service groups according to an exemplary embodiment of the present invention.

FIG. 12 is a diagram illustrating a link resource distribution method of a multiple peer service group according to an exemplary embodiment of the present invention.

### DETAILED DESCRIPTION OF THE EMBODIMENTS

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

In an entire specification, a mobile station (MS) may indicate a terminal, a mobile terminal (MT), an advanced mobile station (AMS), a high reliability mobile station (HR-MS), a subscriber station (SS), a portable subscriber station (PSS), an access terminal (AT), and user equipment (UE), and may include an entire function or a partial function of the MT, the MS, the AMS, the HR-MS, the SS, the PSS, the AT, and the UE.

Further, a base station (BS) may indicate an advanced base station (ABS), a high reliability base station (HR-BS), a node B, an evolved node B(eNodeB), an access point (AP), a radio access station (RAS), a base transceiver station (BTS), a mobile multihop relay (MMR)-BS, a relay station (RS) that performs a BS function, a relay node (RN) that performs a BS function an advanced relay station (ARS) that performs a BS function, a high reliability relay station (HR-RS) that performs a BS function, a small BS [a femto BS, a home node B (HNB), a home eNodeB (HeNB), a pico BS, a metro BS, and a micro BS] and may include an entire function or a partial function of the ABS, the node B, the eNodeB, the AP, the RAS, the BTS, the MMR-BS, the RS, the RN, the ARS, the HR-RS, and the small BS.

In addition, unless explicitly described to the contrary, the word “comprise” and variations such as “comprises” or “comprising” will be understood to imply the inclusion of stated elements but not the exclusion of any other elements. In addition, the terms “-er”, “unit”, “-or”, “module”, and “block” described in the specification mean units for processing at least one function and operation, and can be implemented by hardware components or software components and combinations thereof.

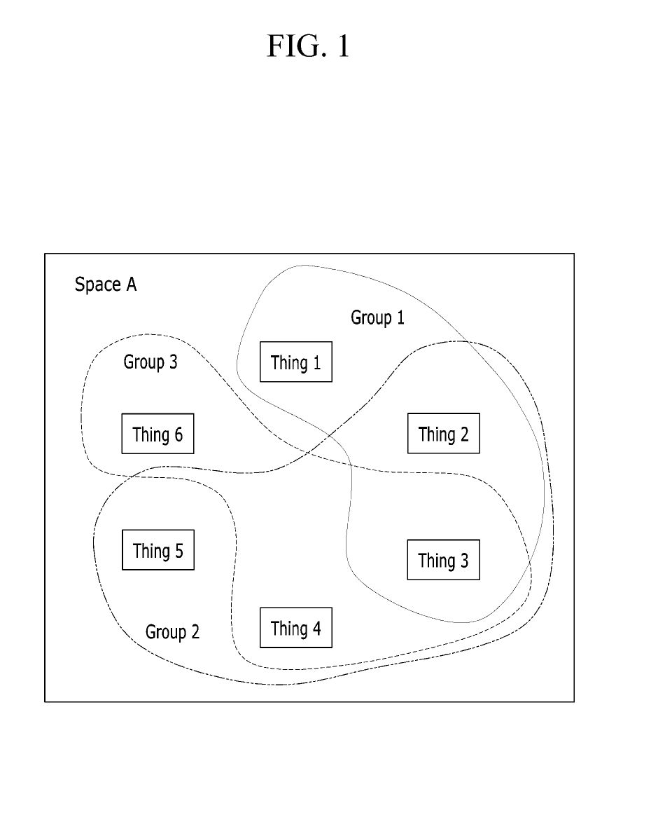

FIG. 1 is a diagram illustrating a network in which each terminal is included in at least one group of a plurality of groups that are included in a space.

Referring to FIG. 1, a plurality of things exists at a random space. A thing 1, a thing 2, and a thing 3 may form a group 1 and perform a service 1. The thing 2, the thing 3, a thing 4, and a thing 5 may form a group 2 and perform a service 2. The thing 3, the thing 4, and a thing 6 may form a group 3 and perform a service 3.

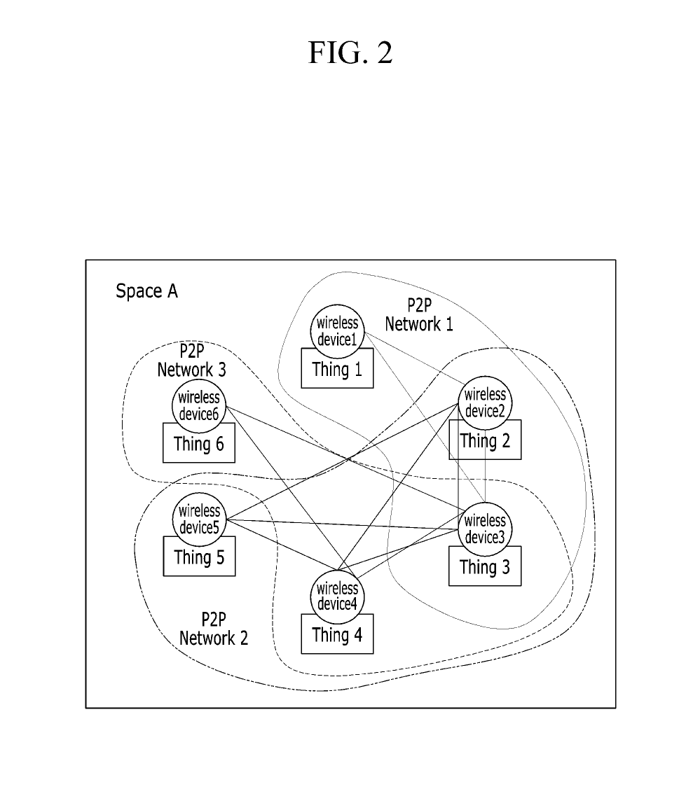

FIG. 2 is a diagram illustrating an example in which each thing of FIG. 1 generates a peer service group.

Referring to FIG. 2, the thing 2 and the thing 4 simultaneously participate in a peer service group 1 and a peer service group 2. The thing 3 participates in all of the peer service group 1, the peer service group 2, and a peer service group 3.

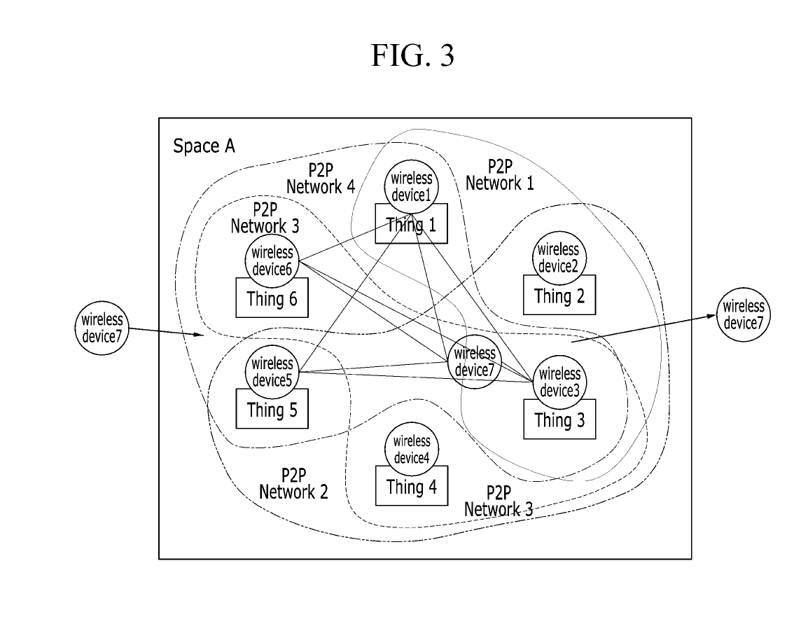

FIG. 3 is a diagram illustrating an example in which a new thing participates in the peer service group of FIG. 2 and generates a new peer service group.

Referring to FIG. 3, a thing that is included at a random space generates a peer service group, and a new thing 7 participates in the peer service group. The thing 7 generates a new peer service group together with the thing 1, the thing 3, the thing 5, and the thing 6, and escapes from the random space.

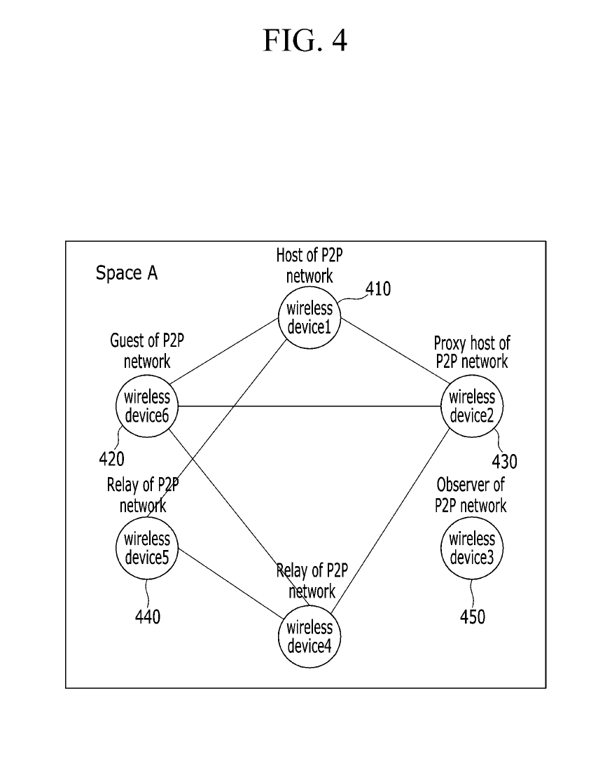

FIG. 4 is a diagram illustrating a peer service group using a low power wireless link according to an exemplary embodiment of the present invention.

The peer service group of FIG. 4 may include a PAC network, and in an exemplary embodiment of the present invention, each peer may search for another peers and generate a peer service group, or may participate in neighbor peer service group.

A peer service group according to an exemplary embodiment of the present invention may include a host of a peer service group 410 and a guest of a peer service group 420 as a main constituent element, a proxy host of a peer service group 430 and a relay of a peer service group 440 as an auxiliary constituent element, and an observer of a peer service group 450.

The host peer 410 of the peer service group is a peer that can generate a peer service group and may provide a P2P service through the peer service group. That is, host peer 410 is a component that can initiate a peer service (so-called ‘initiator’). Further, the host peer 410 may define a mission and a peer group of the peer service group and authenticate another peer that requests a subscription.

The guest peer 420 of the peer service group is a peer that can participate in a peer service group and, may provide a P2P service to another peer included in the peer service group or be provided the P2P service from the another peer. That is, guest peer 420 is a component that can participate in a peer service group (so-called ‘participant’).

The proxy host peer 430 of the peer service group is a peer that can act a role of the host peer 410 instead of the host peer 410. When the host peer 410 leaves from a peer service group or requests the role of the host peer 410 to the proxy host peer 430, the proxy host peer 430 may operate instead of the host peer 410.

The relay peer 440 of the peer service group is a peer that can relay a message in the peer service group. When a wireless link is not connected between the host peer 410 and the guest peer 420 or guest peers, the relay peer 440 may relay a message between peers.

The observer peer 450 of the peer service group may not participate in a configuration of the peer service group, but may observe a message that is transmitted and received between the host peer 410 and the guest peer 420.

A link of the peer service group includes a host-guest link, host-proxy host link, a proxy host-guest link, a host-relay link, and a guest-relay link, and in each link, a radio channel resource and a time resource are distributed as a communication resource.

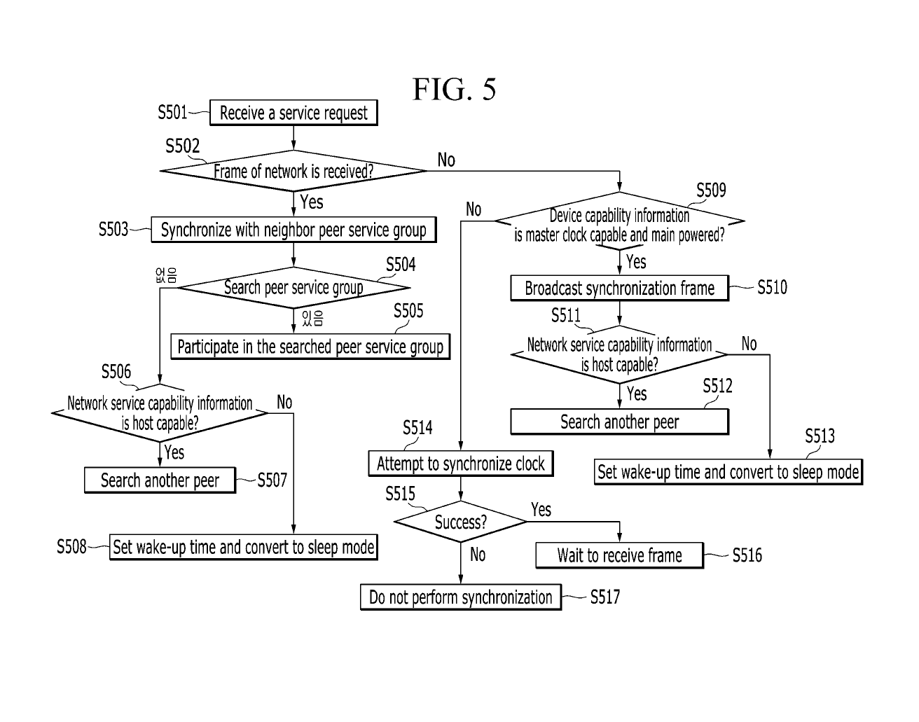

FIG. 5 is a flowchart illustrating an initialization process of a peer that is included in a peer service group according to an exemplary embodiment of the present invention.

Each peer has device capability information and network service capability information as initial information. In this case, the device capability information includes master clock capable, proxy host capable, peer relay capable, main powered, security capable, a dedicated control channel, and always-on receiver.

The network service capability information is information representing a network ability to support an application service of a wireless peer service group, and includes host capable, real-time capable, reliable connection capable, group connection capable, and burst traffic capable.

The peer may determine a function in a peer service group according to device capability information and network service capability information and initialize itself.

First, a peer receives peer service request from a user (S501). In this case, when power of the peer is turned on or the peer moves on another region, the peer receives a frame from peer service group in the vicinity to synchronize clocks with a neighbor peer service group (S502). If a frame is received from the peer service group in the vicinity, the peer synchronizes a clock with the neighbor peer service group using a network clock synchronization frame of received frames (S503).

Thereafter, the peer searches one of the neighbor peer service group that provides the requested peer service using the received frames (S504). If there is a neighbor peer service group that provides the requested peer service, the peer participates in the neighbor peer service group (S505). However, if there is no neighbor peer service group that provides the requested peer service, the peer searches for network service capability information in the received frame to generating a peer service group that can provide the requested peer service. That is, the peer determines whether the network service capability information is host capable or not (S506). If the network service capability information is host capable, the peer searches for another peer (S507). If the network service capability information is not host capable, the peer sets a wake-up time and converts a mode thereof to a sleep mode (S508).

If a frame is not received, the peer determines whether device capability information is master clock capable and main power supply (S509), and if device capability information is master clock capable and main power supply, the peer broadcasts synchronization frames (S510) and searches for network service capability information. The peer determines whether network service capability information is host capable (S511), and if network service capability information is host capable, the peer searches for an another peer to generate a peer service group (S512).

If network service capability information is not host capable, the peer sets a wake-up time and converts a mode thereof to a sleep mode (S513).

If device capability information is not master clock capable and main power supply at step S509, by adjusting a sync listen interval, the peer attempts to synchronize the clock (S514). The peer determines whether clock synchronization has succeeded within the number of synchronization attempts (S515). If clock synchronization has succeeded within the number of synchronization attempts, the peer again wait to receive a frame (S516). If clock synchronization has not succeeded within the number of synchronization attempts, i.e., if the number of determined synchronization attempts is exceeded, the peer does not perform synchronization (S517).

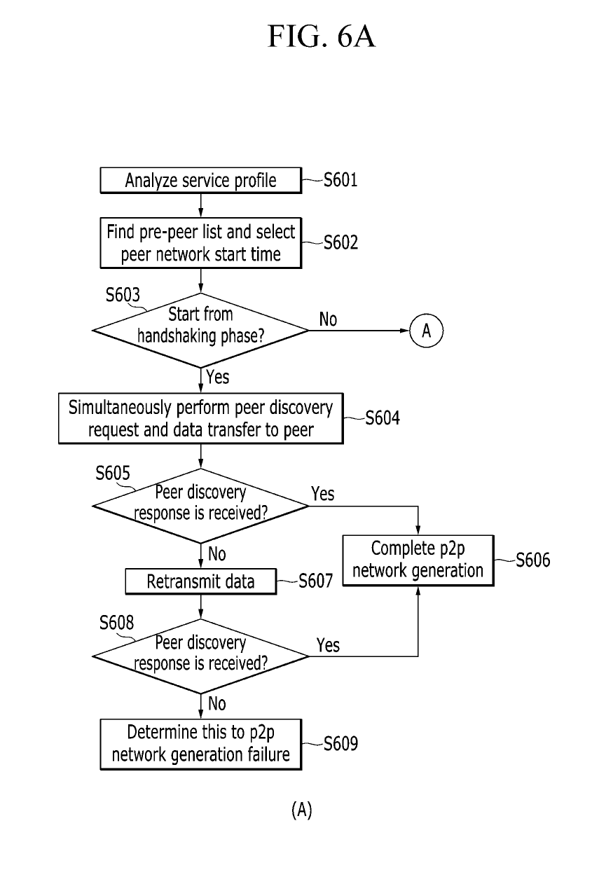

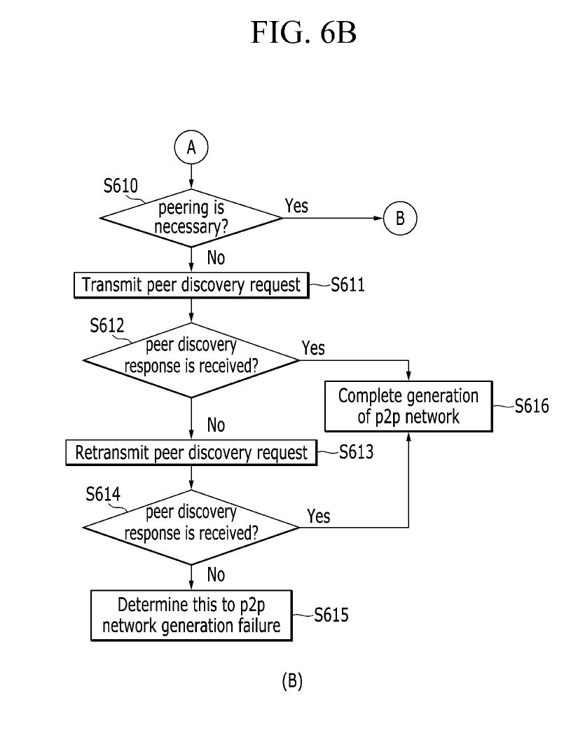

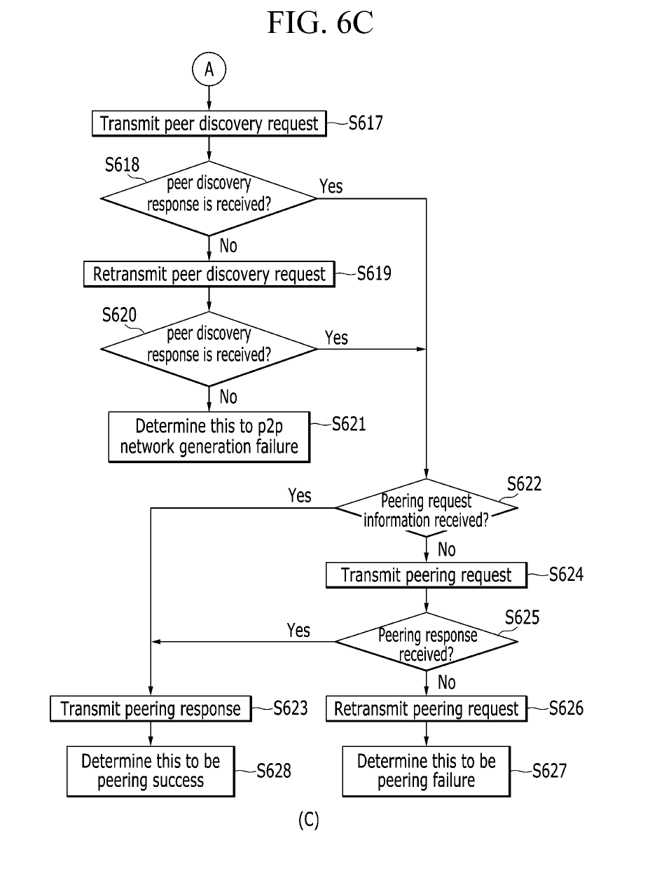

FIG. 6 is a flowchart illustrating a method of generating a single peer network according to an exemplary embodiment of the present invention.

The host peer 410 of peers of the peer service group analyzes a service profile of peer service group included in the host peer and, and prepares a kind and the minimum request number of a device constituting the network, information about a network service procedure, and scheduling information that allocates a link resource on a network phase basis (S601). Thereafter, the host peer 410 monitors peer service group in the vicinity and perform a clock synchronization procedure with neighbor peer service group. In this case, the host peer 410 finds a pre-peer list from a capability advertisement information of a peripheral device received through the network synchronization procedure, and selects a peer network start time of the neighbor peer service group (S602).

Thereafter, the host peer 410 may determine whether to start a process of generating the peer service group from a handshaking phase according to a phase of the peer service group (S603). In this case, the phase of the peer service group may be determined according to a requested peer service.

Referring to FIG. 6 (A), a process of generating the peer service group starting from a handshaking phase will be described. In the handshaking phase, peer discovery request from the host peer 410 and data request from guest peers are simultaneously performed (S604). For example, in the handshaking phase, the host peer 410 may transmit data required together with a peer discovery request.

The host peer 410 determines whether a peer discovery response or peer data acknowledgement (ACK) is received within a predetermined time (S605), and if a peer discovery response or peer data ACK is received within a predetermined time, the host peer group 410 completes generation of the peer service group (S606). If a peer discovery response or peer data ACK is not received within a predetermined time, the host peer 410 retransmits data together with the peer discovery request (S607). The host peer 410 determines whether a peer discovery response or peer data ACK is received within a predetermined time (S608), and if a peer discovery response or peer data ACK is not received within a predetermined time, the host peer 410 determines this to be a peer service group generation failure (S609).

Referring to FIG. 6 (B), when the peer service is not started from a handshaking phase, the host peer 410 determines whether peering is necessary (S610). If peering is unnecessary, the host peer 410 transmits a peer discovery request and awaits a response (S611). The host peer 410 determines whether a peer discovery response is received within a predetermined time (S612), and if a peer discovery response is not received within a predetermined time, the host peer 410 retransmits a peer discovery request (S613). The host peer 410 determines whether a peer discovery response is received within a predetermined time (S614), and if a peer discovery response is not received within a predetermined time, the host peer 410 determines this to be a peer service group generation failure (S615). If a peer discovery response is received within a predetermined time at step S612, the host peer 410 enters a P2P (data) phase, i.e., completes generation of the peer service group (S616).

If peering is necessary at step S610, the host peer 410 transmits a peer discovery request and awaits a response (S617). The host peer 410 determines whether a peer discovery response is received within a predetermined time (S618), and if a peer discovery response is not received within a predetermined time, the host peer 410 retransmits a peer discovery request (S619). The host peer 410 determines whether a peer discovery response is received within a predetermined time (S620), and if a peer discovery response is not received within a predetermined time, the host peer 410 determines this to be a peer service group generation failure (S621). If a peer discovery response is received within a predetermined time, the host peer 410 enters a peering phase. The following paragraphs describe the peering phase.

If the guest peer 420 transmits peering request information together with a peer discovery response, the host peer 410 transmits a peering response (S622). However, if peering procedure is pre-determined in a separate way with the peer discovery procedure according to the service profile, the host peer 410 transmits peering request to the guest peer that transmitted the peer discovery response, and waits (S624). If a response to the peering request from a guest peer 420 is not received within a predetermined time (S625), the host peer 410 retransmits peering request (S626). If a peering response is not received after the retransmission of peering request, the host peer 410 determines this to be a peering failure (S627). However, if the peering response is received within the predetermined time (S625), the host peer 410 transmits peering response (S623) and completes peering (S628). After the peering phase, the host peer 410 enters P2P phase.

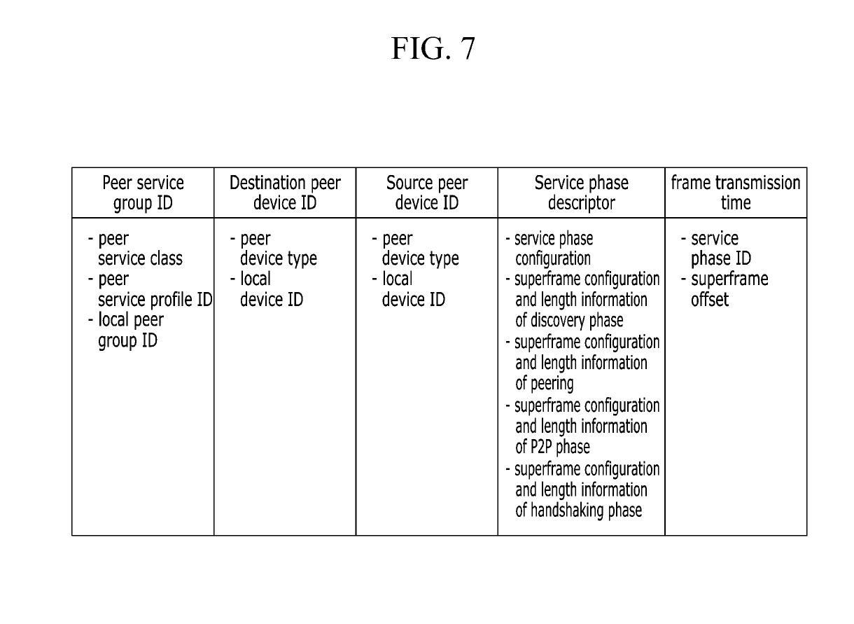

FIG. 7 is a diagram illustrating a header of a media access control (MAC) frame of a peer service group according to an exemplary embodiment of the present invention.

Referring to FIG. 7, a header of a MAC frame of a peer service group according to an exemplary embodiment of the present invention includes a peer service group ID, a destination peer device ID, a source peer device ID, a service phase descriptor, and a frame transmission time.

The peer service group ID may include a service class of peer group, a peer service profile ID and a local peer group ID.

The destination peer device ID may include a peer device type and a local device ID.

The source peer device ID may include a peer device type and a local device ID.

The service phase descriptor includes a service phase configuration, superframe configuration and length information of a discovery phase, peering phase, P2P phase and handshaking phase.

The frame transmission time includes a service phase ID and superframe offset.

A peer service group according to an exemplary embodiment of the present invention may form a link between peers with devices in which cooperation is available for a specific mission. Therefore, the peer service group ID is formed with a mission ID of the peer service group and a multiple peer service group ID. The mission ID of the peer service group is formed with a peer service class and service profile ID. In this case, the multiple peer service group ID (local peer group ID) is used for distinguishing the peer service group from another peer service group that performs the same mission among a plurality of peer service groups.

For the purpose of peer service, service phase descriptor is transferred to each peer. The service phase descriptor may represent a service phase configuration method according to a mission, a superframe configuration and length information of each phase and a data transfer characteristic between peers.

The peer device identifier includes a destination peer device ID and a source peer device ID. The peer device identifier may represent a peer to peer connection relationship between the peer devices, and collect P2P relationship information that displays a relative location of the peer device through the peer device identifier. Thereafter, the P2P relation map may be provided to each peer that is included in the peer service group through the host peer 410.

The frame transmission time may represent a slot in the superframe of the service phase where the frame is transmitted.

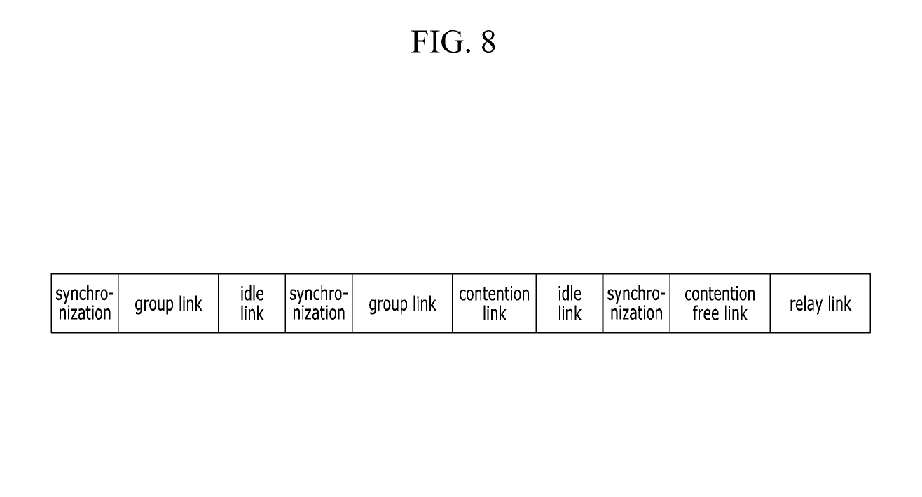

FIG. 8 is a diagram illustrating a link represented by superframe according to an exemplary embodiment of the present invention.

The peer service group uses a basic time slot of a fixed length in a unit of a time resource. In FIG. 8, each link resource is represented with a relative length to a basic time slot, and a length of a basic time slot may be represented with the number of a MAC frame of a standard length that can transmit based on a data rate of a physical layer (PHY).

Referring to FIG. 8, a group link resource is a link resource in which the host peer 410 or the proxy host peer 430 exclusively transfers a message or group-casts a message to all peers included in a peer service group. The host peer 410 accesses to the group link resource with prioritized slotted Carrier Sense Multiple Access/Collision Avoidance (CSMA/CA), and the proxy host of the peer service group 430 accesses a link resource with slotted CSMA/CA.

The guest peer 420 respectively accesses a link resource with a slotted CSMA/CA. Back-off may be allocated with a hash value according to a peer ID.

A contention link resource is a link resource used when a message is interactively transferred between the guest peer 420 and host peer 410 or a plurality of guest peer. The host peer 410 and the guest peer 420 access the contention link resource with the slotted CSMA/CA. Backoff may be allocated with a hash value according to the device identifier of a peer.

A contention free link resource is a link resource allocated through peering procedure between peers of peer service group. The contention free link may be set as one way link or two way links between peers. Each peer access the contention free link resource (two way) with the slotted CSMA/CA. Backoff may be allocated with a hash value according to the device identifier of a peer.

A relay link resource is a link resource that is used when relaying a message of the host peer 410 to the guest peer 420 or when relaying a message of the guest peer 420 to the host peer 410. In the relay from the host peer 410 to the guest peer 420 relay peer 440 accesses a link resource with a prioritized slotted CSMA/CA, and in the relay between guest peer 420 relay peer 440 accesses a link with the slotted CSMA/CA.

An idle resource is a period for a time in which each peer that is included in the peer service group does not simultaneously attempt message transfer, and is a period used in a sleep mode for energy savings or when allocating to another peer service group for operating a multiple peer service group.

A peer service group according to an exemplary embodiment of the present invention may be operated through an allocation order of each link resource of FIG. 8 and the number of time slots corresponding to a link resource. In this case, a phase of the peer service group, which is a combination of a link resource, may have several combinations according to a mission of the peer service group and characteristics of constituent elements. Each service phase may be configured of superframe and each superframe may be repeated until the end of the service phase.

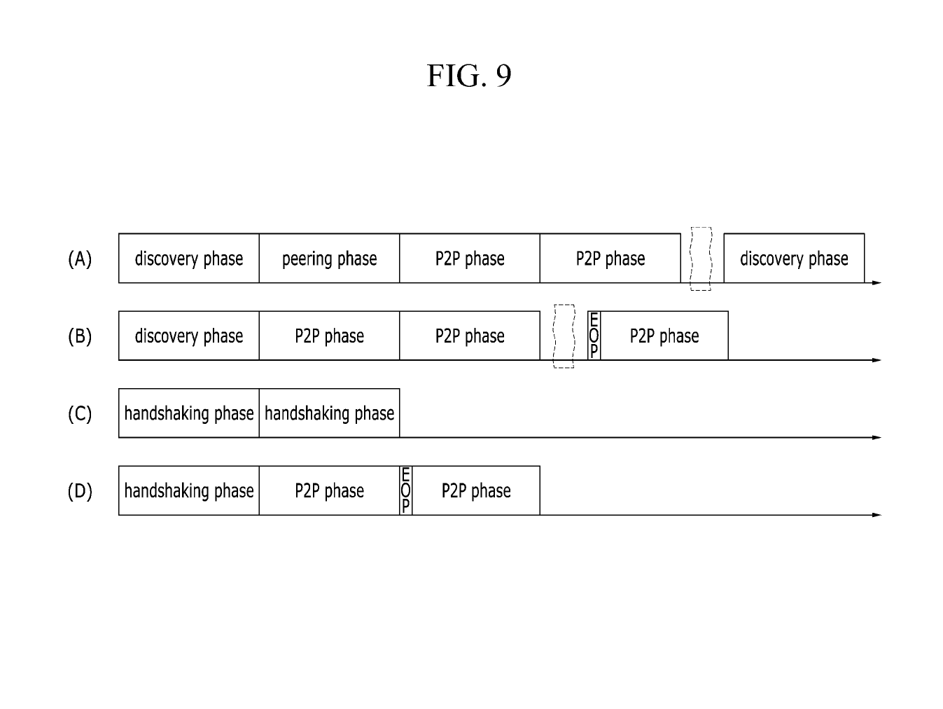

FIG. 9 is a diagram illustrating a phase configuration method of a peer service according to an exemplary embodiment of the present invention.

A peer service group according to an exemplary embodiment of the present invention may set a different link resource allocation method for each service phase and be represented in order of a phase configured of superaframe. In this case, a phase of the peer service group may include a discovery phase, a peering phase, a P2P phase, and a handshaking phase.

First, when the peer service group is continuously operated and maintained, in order to fixedly form the peer service group, the discovery phase is a step in which a link resource for advertisement of the host peer 410 or discovery of constituent element of peer service group for association of a peer.

The peering phase is a step that allocates a link resource to a candidate peer for association after the discovery phase.

The P2P phase is a step in which a link resource for data exchange between peers is allocated after the peer service group is formed.

The handshaking phase is a step that allocates a link resource for simultaneously exchanging data and discovering of peer without peering procedure.

FIG. 9 (a) represents a service of peer service group when a peer service group is continuously operated and maintained for a long time period. In this case, a discovery phase, peering phase and a P2P phase are alternately disposed. Release of the peer service group is determined by a peer service group release instruction of the host peer 410.

FIG. 9 (b) represents a service of peer service group when a peer service group is operated and maintained for a short time period. In this case, after a discovery phase, an extended P2P data phase is disposed. Release of the peer service group is determined when the host peer 410 notifies that a specific P2P data phase is the end (end of P2P (EOP)).

FIG. 9 (c) represents a service of peer service group when data transfer is allowed for a short time period as a mobile communication device instantaneously forms a peer service group. In this case, only a handshaking phase may be disposed.

FIG. 9 (d) represents a service of peer service group when a data transfer time is fully secured, but a mobile communication device instantaneously forms a peer service group. In this case, after a handshaking phase, a P2P data phase may be disposed. Release of the peer service group may be determined when the host peer 410 notifies that a specific P2P data phase is the end or when there is no transferred P2P data for a predetermined time period.

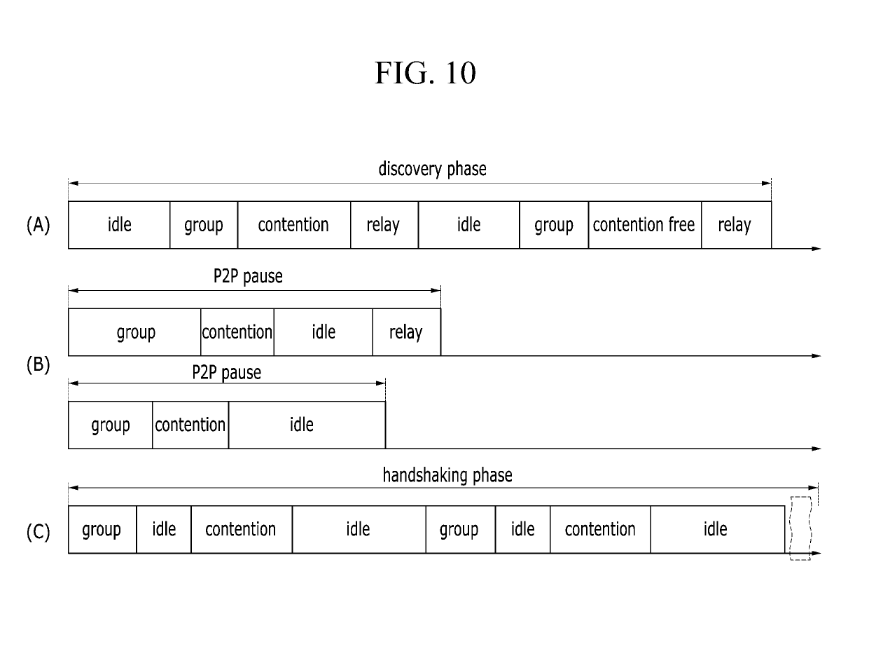

FIG. 10 is a diagram illustrating superframe of each phase of a peer service according to an exemplary embodiment of the present invention.

Referring to FIG. 10 (a), in the discovery phase, a idle link, a group link, a contention link, and a relay link are disposed in order, and a time slot length is determined on each link basis. In this case, a pattern in which a link resource is disposed and a length of a time slot may be changed according to a target time that is consumed for generating a peer service group, a peer member size of the peer service group (e.g., peer number that is included in a multiple peer service group), and a transmitting distance of the peer service group.

In the discovery phase, the host peer 410 determines a idle link, searches for an adjacent peer service group, and determines a superframe start time. Thereafter, the host peer 410 transfers a discovery message including a peer service group descriptor, a discovery phase descriptor, and a peering phase descriptor at a group link segment. The relay of the peer service group 440, having received a discovery message, retransmits a discovery message at a relay segment.

In the discovery phase, the guest peer 420 may maintain a listen mode by a predetermined time slot according to a wake-up cycle by a quorum operation of the peer service group. In this case, the guest peer 420 is the observer peer 450 and may collect information by searching for an adjacent peer service group. When the guest peer 420 finds a discovery message, the guest peer 420 may transmit a discovery response together with adjacent peer device information at a near guest link segment.

Referring to FIG. 10 (b), in a P2P data phase, a group link, a contention link, an idle link, and a relay link are sequentially disposed, and a length of a time slot is determined on each link basis. In this case, a pattern in which a link resource is disposed and a length of a time slot may be changed according to a mission of the peer service group, a magnitude of a message that is generated between peers, the number of peer service group peers, and a transmitting distance reference of the peer service group. A link access may follow an existing link access method according to a link use device.

Referring to FIG. 10 (c), at the handshaking phase, a group link, an idle link, a contention link, and an idle link are sequentially disposed, and a length of a time slot is determined on each link basis. In this case, a pattern in which a link resource is disposed and a length of a time slot may be changed according to a target time that is consumed for collecting information of the peer service group, a size of a peer member of the peer service group, a mission of the peer service group, and a magnitude of a message that is generated between peers. The link access may follow an existing link access method according to a link use device. A plurality of link resource allocation combinations may be repeated to form a handshaking phase.

In the handshaking phase, the host peer 410 transfers a discovery message including a peer service group descriptor, a handshaking phase descriptor, and a P2P data phase descriptor (may not be included according to a case) at a group segment. When a link resource allocation method is formed with only a handshaking phase, the guest peer 420 may transmit a data message. In a handshaking phase, a relay does not operate.

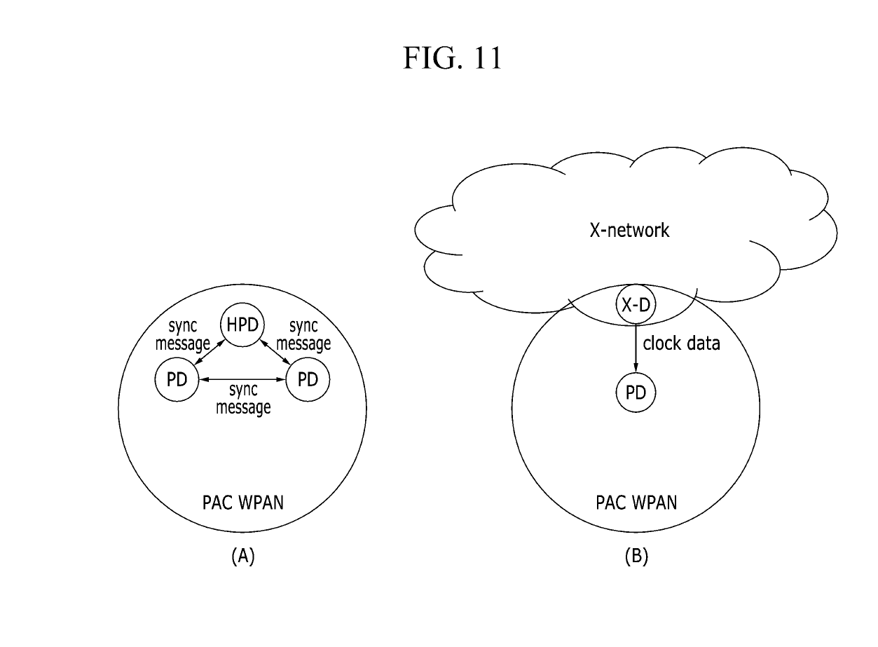

FIG. 11 is a diagram illustrating a time synchronization correction method between peer service groups according to an exemplary embodiment of the present invention.

Referring to FIG. 11, when a plurality of peer service groups simultaneously operate, a time synchronization correction method between peer service groups may be known. A time synchronization method of a peer service group may include a method in which a plurality of peer service groups correct time synchronization by exchanging a message and a method of correcting time synchronization by an outside network.

Referring to FIG. 11 (a), a peer device (PD) included in the peer service group corrects synchronization based on a time of the host peer 410. That is, the peer device may exchange a message with the host peer 410 and correct time synchronization by estimating an arrival time of the exchanged message. When the peer device corrects time synchronization between a plurality of peer service groups, the peer device corrects synchronization in another peer service group based on a host time of a first formed first peer service group. In this case, by participating in the first peer service group as an observer of the peer service group 450 of the first peer service group, a host peer 410 of another peer service group may correct time synchronization. In this case, a start location of an actual time slot is designated in consideration of a correction error of time synchronization.

Referring to FIG. 11 (b), when a device using a PAC capable network is connected to another kind of global network, both networks may be synchronized based on a time of the global network. In this case, a separate time synchronization procedure is not required in every peer service group, and time synchronization is available even in a multiple peer service group.

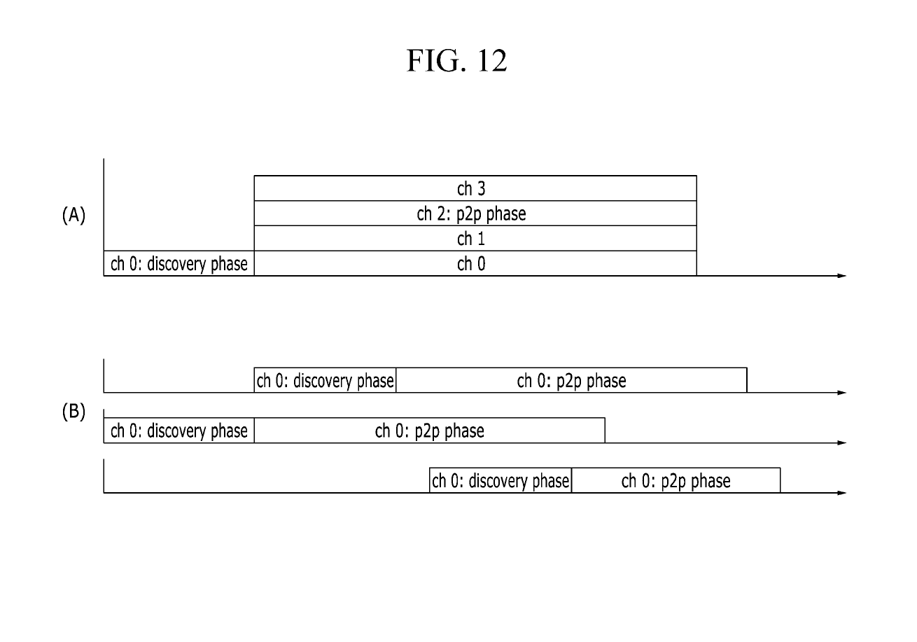

FIG. 12 is a diagram illustrating a link resource distribution method of a multiple peer service group according to an exemplary embodiment of the present invention.

Referring to FIG. 12, each device of a multiple peer service group competes to occupy a link resource of the multiple peer service group.

FIG. 12 (a) illustrates a case in which a radio channel that can simultaneously operate a peer that is included in a plurality of peer service groups is several channels (channel 0-channel 3). In this case, the host peer 410 scans an adjacent peer service group and selects a peer service group channel. A discovery message that the host peer 410 transmits may be transmitted through a common channel.

FIG. 12 (b) illustrates a case in which a radio channel that can simultaneously operate a peer device that is included in a plurality of peer service groups is one (channel 0). In this case, the host peer 410 scans an adjacent peer service group, searches for a idle slot, and maximally avoids link access competition. When the peer device competes with another peer device, the peer device may be operated according to a CSMA/CA access method that is determined on each link basis.

As described above, according to an exemplary embodiment of the present invention, each peer of a peer service group can search peer service group in the vicinity according to request of user and participate in the neighbor peer service group. If there is no service group in the vicinity, the peer can generate a new peer service group. In this case, peer can access a link resource with various methods according to type of the request and enhance resource use efficiency according to a mission of the peer service group, a size of the peer service group, and a characteristic of the peer service group.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A method in which a peer generates a peer service group, the method comprising:
determining whether a first peer service group that provides a peer service requested from user exists in the vicinity;
participating, if the first peer service group exists, in the first peer service group; and
generating, if the first peer service group does not exist, a second peer service group that provides the peer service.

2. The method of claim 1, further comprises before the determining:
searching frames transmitted from neighbor peer service group that exists in the vicinity; and
synchronizing clock using synchronization frame of the frames.

3. The method of claim 2, further comprising, if the frames have not been received, resetting reception period of the frames and searching the frames again.

4. The method of claim 2, further comprising, if the frames have not been received, determining whether the peer can broadcast synchronization frame through device capability information stored in the peer.

5. The method of claim 4, wherein the determining whether the peer can broadcast the synchronization frame comprises:
determining whether the peer has information of master clock capable and main powered through the device capability information.

6. The method of claim 4, further comprising:
broadcasting, if the peer can broadcast the synchronization frame, the synchronization frame;
determining whether the peer can discover another peer through network service capability information stored in the peer;
discovering, if the peer can discover the another peer, the another peer; and
setting wake-up time and converting a mode thereof to a sleep mode if the peer cannot discover the another peer.

7. The method of claim 1, wherein the generating comprises:
determining whether the peer can discover another peer through network service capability information stored in the peer;
discovering, if the peer can discover the another peer, the another peer; and
setting wake-up time and converting a mode thereof to a sleep mode if the peer cannot discover the another peer.

8. The method of claim 7, wherein the discovering the another peer comprises:
transmitting, if the second peer service group is a handshaking phase, a peer discovery request and data;
retransmitting the peer discovery request and data when a peer discovery response or peer data acknowledgement (ACK) is not received within a predetermined first time; and
completing generation of the second peer service group when the peer discovery response or the ACK is received within the first time.

9. The method of claim 8, wherein the discovering the another peer further comprises:
completing generation of the second peer service group when the peer discovery response or the ACK is received within a predetermined second time after the retransmission; and
determining a generation failure of the second peer service group when the peer discovery response or the ACK is not received within the second time.

10. The method of claim 7, wherein the discover the another peer comprises:
determining, if the start phase is not a handshaking phase, whether peering is necessary;
transmitting, if peering is unnecessary, a peer discovery request;
retransmitting the peer discovery request when the peer discovery response is not received within a predetermined first time; and
completing generation of the second peer service group when the peer discovery response is received within the first time.

11. The method of claim 10, wherein the discover the another peer further comprises:
completing generation of the second peer service group when the peer discovery response is received within a predetermined second time after the retransmission; and
determining a generation failure of the second peer service group when the peer discovery response is not received within the second time.

12. The method of claim 10, wherein the discover the another peer further comprises:
transmitting, if peering is necessary, a peer discovery request;
retransmitting the peer discovery request when the peer discovery response is not received within a predetermined first time;
determining whether a peering request information is received when the peer discovery response is received within the first time;
transmitting, if the peering request information is received, a first peering response; and
completing generation of the second peer service group.

13. The method of claim 12, further comprising:
transmitting, if the peering request information is not received, a peering request;
transmitting a third peering response when a second peering response to the peering request is received; and
completing generation of the second peer service group.

14. The method of claim 13, further comprising:
retransmitting, it the second peering response is not received, the peering request;
transmitting a fifth peering response when a fourth peering response to the retransmitted peering request is received; and
completing generation of the second peer service group.

15. The method of claim 10, wherein the discover the another peer further comprises:
transmitting a peering response and completing generation of the second peer service group when the peer discovery response is received within a predetermined second time after the retransmission; and
determining a generation failure of the second peer service group when the peer discovery response is not received within the second time.

16. The method of claim 7, wherein the peer performs a server function, defines a mission of a peer service group and a peer group, and is a host peer that authenticates the another peer.

17. The method of claim 16, wherein the other peer is a guest peer that requests generation of a peer service group to the host peer.

18. A method in which a peer accesses to a link resource of a peer service group, the method comprising:
receiving service phase descriptor; and
accessing the link resource according to the service phase descriptor,
wherein the service phase descriptor includes information about service phase determined according to peer service requested by user.

19. The method of claim 18, wherein the information about the service phase comprises discovery phase, peering phase, P2P data phase and handshaking phase, and each phase can be represented superframe including at least one of group link, idle link, contention link, contention free link and relay link.

20. The method of claim 19, further comprising:
determining, when the service phase is the discovery phase, a start time of the superframe; and
transmitting, by a first group link, a discovery message to another peer,
wherein the peer accesses the first host link with a prioritized slotted Carrier Sense Multiple Access/Collision Avoidance (CSMA/CA) method.
